(19) United States
(12) Patent Application Publication
(10) Pub. No.: US 2015/0308660 A1
(43) Pub. Date: Oct. 29, 2015

(54) LIGHT ENGINE DEVICE

(71) Applicants: Shih-Yu Chiu, Taoyuan County (TW); Cheng-Pin Cho, Taoyuan County (TW); Tzung-Shin Li, Taoyuan County (TW); Shao-Han Tan, Taoyuan County (TW)

(72) Inventors: Shih-Yu Chiu, Taoyuan County (TW); Cheng-Pin Cho, Taoyuan County (TW); Tzung-Shin Li, Taoyuan County (TW); Shao-Han Tan, Taoyuan County (TW)

(21) Appl. No.: 14/263,187

(22) Filed: Apr. 28, 2014

(51) Int. Cl. F21V 13/04; F21K 99/00

(52) U.S. Cl. CPC F21V 13/04; F21K 9/00; F21Y 2101/02

(57) ABSTRACT

A light Engine device includes a base, a light source module, a light reflecting element, an optical module and a sleeve. The light source module has a light-emitting diode unit and a substrate. The light reflecting element has a first opening, a cup body and a second opening. The optical module has an interface portion and a lens portion. The sleeve has a first port, a sleeve body and a second port. The light emitting diode unit generates a light beam, and the emitted light pattern and light intensity are regulated by the first optical effect and second optical effect.

### BACKGROUND

1. Technical Field

The present invention relates to a lighting device, particularly to a light engine device having low power loss and high luminous efficiency.

2. Related Art

Since the light emitting diode has the advantage of low energy consumption, high luminous efficiency and long usage life, now there are so many illumination companies which replace other traditional illumination system with the light emitting diode lighting system, such as incandescent bulb, fluorescent bulb, or traditional tungsten filament bulb.

However, mostly the illumination companies design the products by technology orientation, and there is no such a standard among all the illumination companies. Therefore, even though the illumination companies have their own techniques, the market size of the illumination industry cannot be expanded under the condition that the standard of the products cannot be united.

The light emitting diode illumination system is created by assembling different parts together. Generally speaking, the illumination system includes a light engine module, an optical component, and a power supply. When assembling an illumination system, the manufacturer usually purchases every single part from different suppliers, and then assembles all the parts together. However, purchasing parts from different suppliers would result in various part standards that is hard to integrate in order to make a functional system, and manufacturing the illumination system in this way cannot make the illumination efficient.

In view of the foregoing problem, from 2010, an alliance “ZHAGA” is developed. The alliance establishes a light engine platform, and sets an open standard which includes standard such as standard platform and united specification.

The light engine specification established by the ZHAGA is primarily designed based on the traditional lamp device. Nevertheless, the modern light engine mainly combines a light source of a light emitting diode with a light collecting device to regulate the light direction. Therefore, the light engine cannot take full advantages of high directional and small light emitting area of the light emitting diode.

In view of this, the present invention provides a light engine device to solve the drawback of the conventional technique.

### BRIEF SUMMARY

The present invention provides a light engine device, by which the light generated from the light emitting diode can be treated by a first optical reaction and a second optical reaction to reach the effect of low energy consumption and high efficiency light guiding.

Moreover, due to the aforementioned light engine device, the light intensity generated by the light emitting diode can be increased and the light pattern of the light emitted from the light emitting diode can be easily regulated.

In order to achieve the aforementioned purpose, the present invention provides a light engine device, including a base, a light source module, a light reflecting element, an optical module and a sleeve. The light source module is provided on one side of the base. The light source module has a light emitting diode unit and a substrate. The light emitting diode unit is provided on one side of the substrate. The light reflecting element is provided on the same side as the light emitting diode unit of the light source module. The light reflecting element has a first opening, a cup body and a second opening. The first opening accommodates the light emitting diode unit. The first opening and the second opening are formed on the opposed sides of the cup body. The diameter of the second opening is larger than that of the first opening. This optical module has an interface portion and a lens portion. One side of the interface unit stacks on and connects to the second opening and the lens portion is formed on the other side of the interface portion. The sleeve has a first port, a sleeve body and a second port. The first port is fixed to the base. The sleeve body covers the light source module, the light reflecting element and at least a portion part of the optical module. The light beam generated from the light emitting diode forms a reflected light beam through a first optical reflection by the light reflecting element, and the reflected light beam forms one of the effect from a focusing action and a diffusion through a second optical reflection by the lens portion.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a disassembling schematic view of an embodiment of the light engine device according to the present invention;

FIG. 2 is a schematic view of another embodiment of the base of the light engine device according to the present invention;

FIG. 3 is an assembling schematic view of each parts of FIG. 1;

FIG. 4 is a schematic view of another embodiment of the cup body of the light engine device according to the present invention;

FIG. 5 is a schematic view of a light route of the embodiment of the light engine of FIG. 4; and

FIGS. 6a-6e is a chart of experiment effect of the embodiment of the light engine.

### DETAILED DESCRIPTION

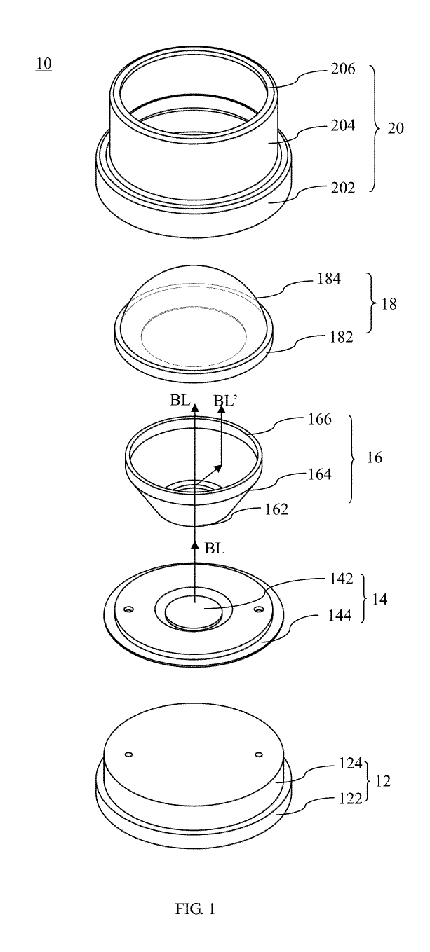

Please refer to FIG. 1. The light engine device 10 includes a base 12, a light module 14, a light reflecting element 16, an optical module 18 and a sleeve 20.

In the present embodiment, the base 12 has a first cylinder 122 and a second cylinder 124. Since the peripheral of the first cylinder 122 is larger than the peripheral of the second cylinder 124, a ladder shape protrusion is formed on the first cylinder 122. The first cylinder 122 and the second cylinder 124 are made of high thermal conductive material, which can swiftly dissipate the heat generated by the light source 14 and/or light reflecting element 16. The high thermal conductive material can be metal, ceramics, graphite or diamond.

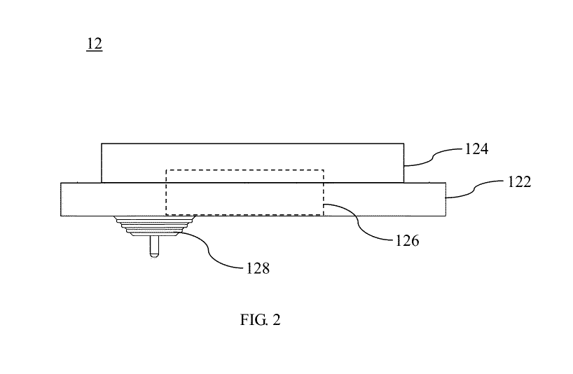

It should be noted that people skilled in the art will appreciate that the base 12 can further include a driving circuit 126 and/or a connecting terminal 128. FIG. 2 illustrates a side view of the base 12 of the light engine device 10 according to another embodiment. In FIG. 2, the driving circuit 126 can be used to drive the light source module 14 to generate a light beam (LB). The connecting terminal 128 can be used to connect a traditional lamp base.

Referring to FIG. 1, the light source module 14 is provided above the base 12. The light source module 14 includes a light emitting diode unit 142 and a substrate 144.

The light emitting diode unit 142 is provided above the substrate 144. In the present embodiment, the light emitting diode unit 142 can include a single light emitting diode or a plurality of chip-on-board light emitting diodes. The chip-on-board light emitting diode is a lambertian planar light source, which has high luminous power and big luminous angle such as from 15 degrees to 140 degrees.

The light reflecting element 16 reflects the light beam LB generated from the light emitting diode unit 142 to generate another light beam LB′ by a single optical reflection. The material of the light reflecting unit 16 is metal.

The light reflecting element 16 includes a first opening 162, a cup body 164, and a second opening 166. The light reflecting element 16 is provided on the top of the light source module 14. The first opening 162 is provided above the light emitting diode unit 142 to accommodate the light emitting diode unit 142. The first opening 162 and the second opening 166 are formed on the opposite ends of the cup body 164, respectively. In the present embodiment, the diameter of the second opening 166 is larger than that of the first opening 162, thereby forming an annular inclined surface for cup body 164.

It is noted that the diameter of the first opening 162 and the second opening 166 can be regulated as needed, and a specific luminous angle of the light beam LB can be made to provide a first optical reaction.

In the present embodiment, the diameter of the first opening 162 is approximately equal to the diameter of the light emitting diode unit 142, and the first opening 162 can accommodate the light emitting diode unit 142. In another embodiment, the diameter of the first opening 162 can also be larger than the diameter of the light emitting diode unit 142.

The optical module 18 can focus or diffuse the light beam LB′ from the light reflecting element 16, and the light beam LB from the light emitting diode unit 142, which is not reflected by the light reflecting element 16. That is to say, the light module 18 can result in very good effect on changing the light route. The material of the optical module 18 can be Poly methyl methacrylate (PMMA), polycarbonates (PC) or silicon dioxide.

The optical module 18 includes an interface portion 182 and a lens portion 184. The interface portion 182 and the lens portion 184 can be separated parts or an integrated single part. The optical module 18 stacks on the second opening 166 to make the bottom part of the interface portion 182 connect the second opening 166, and also forms the lens portion 184 on the top of the interface portion 182. In another embodiment, the interface portion 182 has an annular inclined surface which extends from the outer edge of the interface portion 182 to the light reflecting element 16. The lens portion 184 can be an aspheric lens structure or a Fresnel lens structure, which can be regulated as needed. In the present embodiment, the lens portion 184 is bullet shaped.

Therefore, in the present invention, the light reflecting element 16 collects the light beam LB from the light emitting diode unit 142, and the light route of the light beam LB is unified to form the light beam LB and LB′ which has relatively narrower light route. The optical module 18 is used to focus and diffuse the light beam LB and LB′ to form different light distribution curves. In other words, by regulating the light emitting diode unit 142, the light reflecting element 16 and the optical module 18, dynamically quick switching according to different environments can be achieved.

In another embodiment, a silicon ring (not shown in figures) can be provided between the light reflecting element 16 and the optical module 18. By this arrangement, it is not only increasing the compactness of the light reflecting unit 16 and the optical module 18, but also improving the water-proofing characteristic of the whole light engine device 10.

The sleeve 20 includes a first port 202, a sleeve body 204 and a second port 206. In the present embodiment, a ladder shape annular cover is formed on the outer side of the first port 202, but not limited thereto. The material of the sleeve 20 can be metal or plastic.

The first port 202 is fixed to the base 12 to allow the ladder annular cover to cover the ladder shape protrusion. The sleeve body 204 covers the light source module 14, the light reflecting element 16 and the optical module 18. The lens portion 184 protrudes out of the second port 206. In another embodiment, the lens portion 184 can also be totally covered by the sleeve 20.

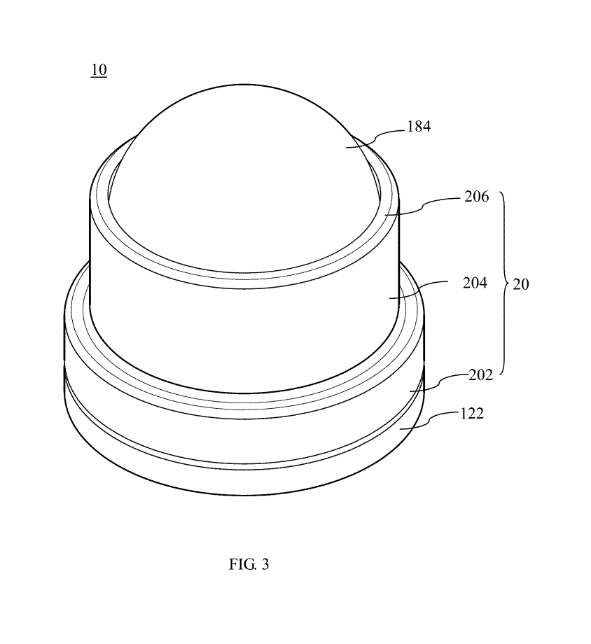

Referring to FIG. 3, the lens portion 184 is provided on the top part of the light engine device 10. The lens portion 184 has a bullet shaped look and protrudes out of the second port 206. The bottom of the light engine device 10 is a round base.

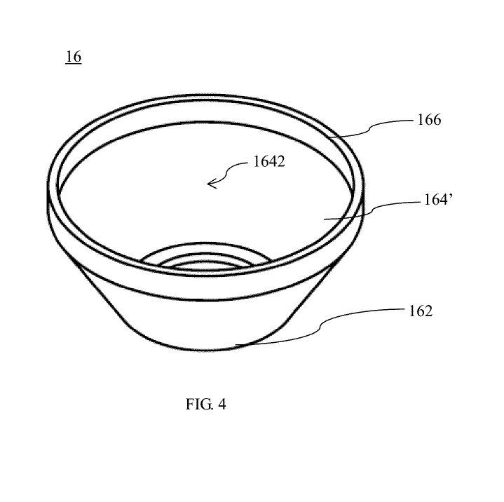

Referring to FIG. 4, the cup body 164 includes a reflection layer 1642. The reflection layer 1642 is formed on the inner wall of the cup body 164 to strengthen the light intensity of parallel light. For example, the material of the reflection layer 1642 can be at least one selected from the group of Al₂O₃, YBO₃, BaSO₄, TiO₂, Ca-pyrophosphate, CA-halophosphate and MgO.

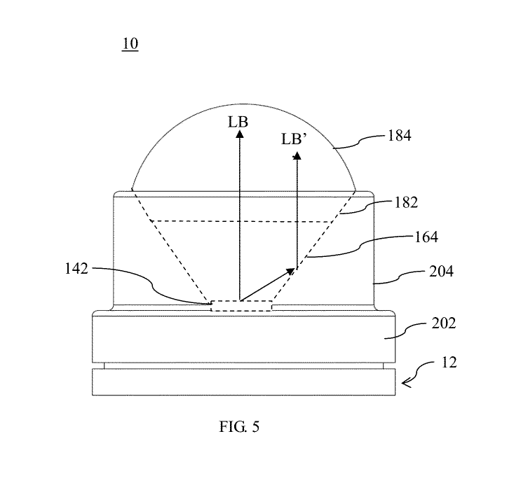

Referring to FIG. 5, the light emitting diode unit 142 on the base 12 generates light beam LB, and the light beam LB with small light radiation angle directly passes through the light reflecting element 16 to reach the interface portion 182. The light beam LB with large light radiation angle is emitted to the cup body 164, and another parallel light beam LB′ is generated by the cup body 164. The two lights beam LB, LB′ are emitted to the interface portion 182 and further emitted to outside of the light engine 10 through the lens portion 184.

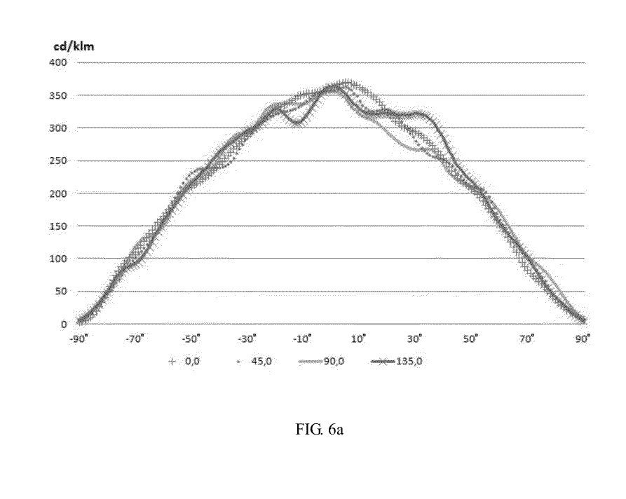

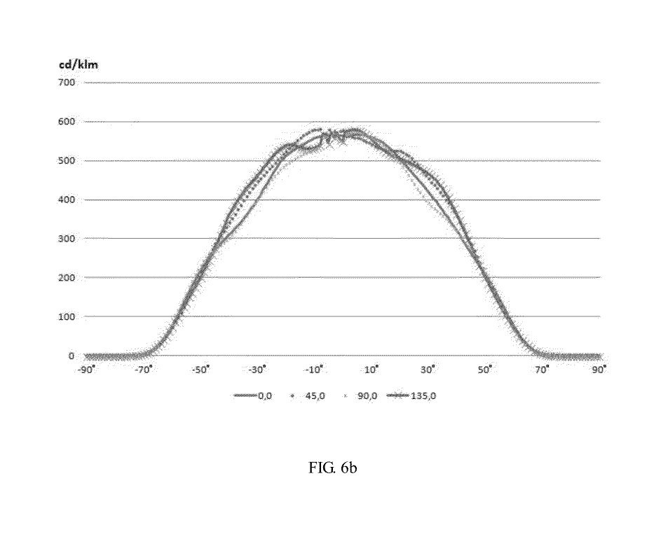

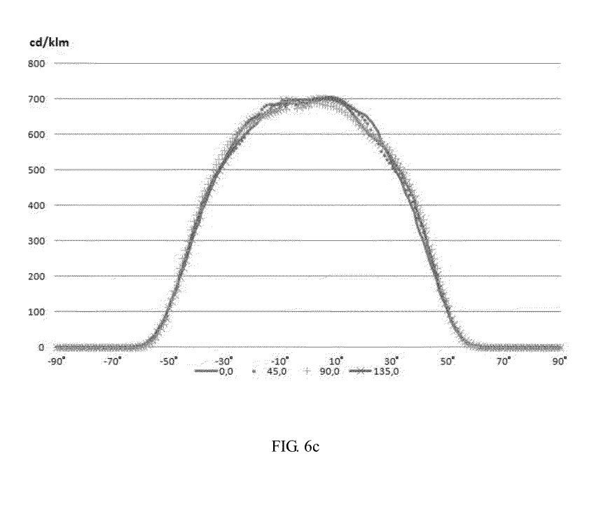

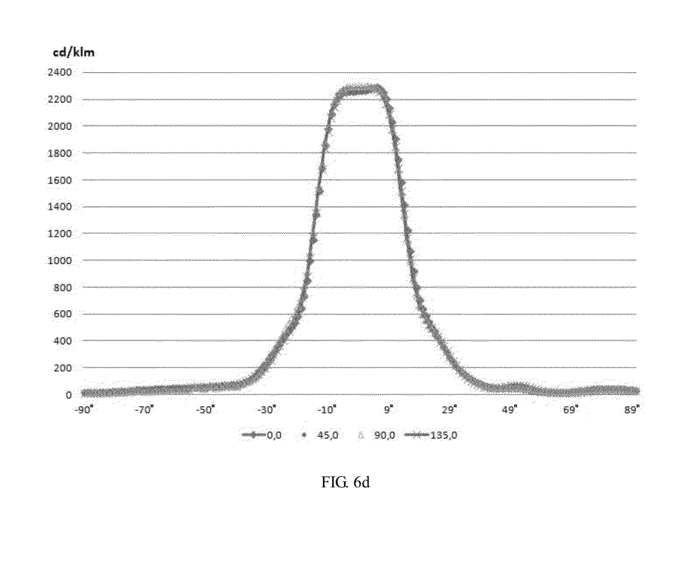

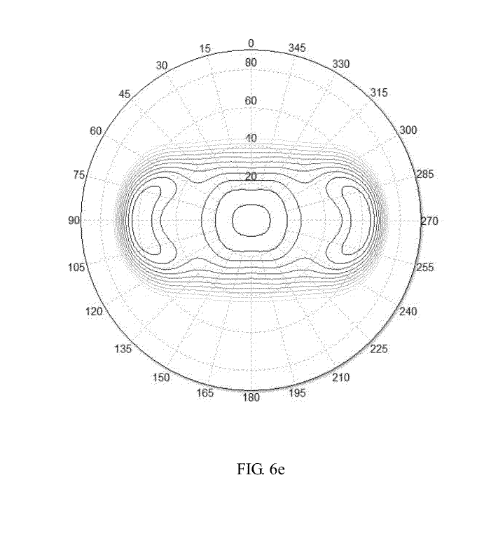

FIG. 6a shows the light intensity of the light generated by the light emitting diode unit after being driven. As shown in FIG. 6a, the middle part of the light has the strongest light intensity, which is about 350 cd/klm.

In FIG. 6b, the light intensity increases to 600 cd/klm after the light passes through the light reflecting element 16.

In FIG. 6c, the light intensity increases to 680 cd/klm after the light directly passes through the optical module 18.

In FIGS. 6b and 6c, the light intensity only doubles after the light goes through one optical reaction.

In FIG. 6d, the light intensity increases up to 2200 cd/klm, which is about 6-7 times compared to FIG. 6a, after the light goes through the first optical reaction and the second optical reaction provided by the combination of light reflecting element 16 and optical module 18.

Besides, the optical module 18 can control the light pattern of the emitted light to form rectangle shape light pattern for long distance illumination, which cannot be achieved by traditional light emitting diode lamps. The light pattern is as shown in FIG. 6e.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light engine device comprising:
a base;
a light source module provided on one side of the base, the light source module including a light emitting diode unit and a substrate, the light emitting diode unit being provided on one side of the substrate;
a light reflecting element provided on the same side as the light emitting diode unit of the light source module, the light reflecting element having a first opening, a cup body and a second opening, wherein the first opening accommodates the light emitting diode unit, the first opening and the second opening are formed on opposed sides of the cup body, and the diameter of the second opening is larger than that of the first opening;
an optical module having an interface portion and a lens portion, one side of the interface portion stacking on and connecting to the second opening, the lens portion being formed on the other side of the interface portion; and
a sleeve having a first port, a sleeve body and a second port, the first port being fixed to the base, the sleeve body covering the light source module, the light reflecting element and at least a portion of the optical module,
wherein a light beam generated from the light emitting diode forms a reflected light through a first optical reflection via the light reflecting element, and the reflected light beam is focused or diffused through a second optical reflection via the lens portion.

2. The light engine device as claimed in claim 1, wherein the light emitting diode unit is single light emitting diode or a plurality of chip-on-board light emitting diodes.

3. The light engine device as claimed in claim 1, wherein the lens portion protrudes out of the second port.

4. The light engine device as claimed in claim 1, wherein the base is composed of metal, ceramics, graphite, or diamond.

5. The light engine device as claimed in claim 1, wherein the light reflecting element is composed of a metal material.

6. The light engine device as claimed in claim 5, wherein the light reflecting element comprising a reflection layer, and the reflection layer is formed on an inner wall of the cup body.

7. The light engine device as claimed in claim 5, wherein the material of the reflection layer is at least one selected from a group of Al2O3, YBO3, BaSO4, TiO2, Ca-pyrophosphate, CA-halophosphate and MgO.

8. The light engine device as claimed in claim 1, wherein the optical module is composed of Polymethylmethacrylate (PMMA), Polycarbonate (PC), or SiO2.

9. The light engine device as claimed in claim 1, wherein the lens portion is an aspheric lens structure or a Fresnel lens structure.

10. The light engine device as claimed in claim 1, wherein the sleeve is made of metal or plastic.

11. The light engine device as claimed in claim 1 further comprising a silicon ring provided between the light reflecting element and the optical module.
